(19) United States
(12) Patent Application Publication
(10) Pub. No.: US 2006/0289354 A1
(43) Pub. Date: Dec. 28, 2006

(54) Method and composition to control the growth of microorganisms in aqueous systems and on substrates

(75) Inventors: Xiangdong Zhou, Cordova, TN (US); Stephen D. Bryant, Bartlett, TN (US); Thomas E. McNeel, Memphis, TN (US)

Correspondence Address: KILYK & BOWERSOX, P.L.L.C., 400 HOLIDAY COURT, SUITE 102, WARRENTON, VA, 20186, US

(73) Assignee: Buckman Laboratories International, Inc.

(21) Appl. No.: 11/153,571

(22) Filed: Jun. 15, 2005

(51) Int. Cl. C02F 3/00

(52) U.S. Cl. 210/601; 424/94.4

(57) ABSTRACT

A method and composition for killing, preventing, or inhibiting the growth of microorganisms in an aqueous system or on a substrate capable of supporting a growth of microorganisms are provided by providing a lactoperoxidase, hydrogen peroxide or a peroxide source, a halide, other than a chloride, or a thiocyanate, and, optionally, an ammonium source, under conditions in which the lactoperoxidase, peroxide from the hydrogen peroxide or peroxide source, halide or thiocyanate and ammonium from the ammonium source interact to provide an antimicrobial agent to the aqueous system or substrate.

### FIELD OF THE INVENTION

The present invention relates to compositions and methods to control the growth of microorganisms in aqueous systems or on substrates such as one or more surfaces of a substrate. The present invention also relates to the formation of an antimicrobial agent by the interaction of lactoperoxidase with other components.

### BACKGROUND OF THE INVENTION

Peroxidases are a group of enzymes widely distributed in nature. Their primary function in nature is to catalyze oxidation reactions while consuming hydrogen peroxide or other oxidative agents. An electron donor (reducing agent) is generally required in order for the oxidation reaction to go forward.

Peroxidase in the presence of hydrogen peroxide and in the presence of halides or thiocyanates as electron donors can generate products that possess a wide range of antimicrobial properties. Peroxidases can vary with respect to the particular halides or thiocyanates with which they can react. For example, myeloperoxidase utilizes Cl⁻, Br⁻, I⁻, or SCN⁻ as the electron donor, and oxidizes them to form antimicrobial hypohalides or hypothiocyanates. Lactoperoxidase catalyzes the oxidation of Br⁻, I⁻, or SCN⁻, but not Cl¹, to generate antimicrobial products. Horseradish peroxidase uses only I⁻ as the electron donor to yield I₂, HIO, and IO⁻. Application areas where antimicrobial peroxidase-halide-H₂O₂ systems have been used include food, dairy, personal care, and veterinary products.

U.S. Pat. No. 5,451,402 to Allen describes a method for killing yeast and sporular microorganisms with haloperoxidase-containing compositions said to be useful in therapeutic antiseptic treatment of human or animal subjects and in vitro applications for disinfection or sterilization of vegetative microorganisms and fungal spores.

U.S. Patent Application Publication No. 2002/0119136 A1 by Johansen relates to an antimicrobial composition containing a Coprinus peroxidase, hydrogen peroxide, and an enhancing agent such as an electron donor. The composition is said to be useful for inhibiting or killing microorganisms present in laundry, on human or animal skin, hair, mucous membranes, oral cavities, teeth, wounds, bruises, and on hard surfaces. Also the composition can be used as a preservative for cosmetics, and for cleaning, disinfecting or inhibiting microbial growth on process equipment used for water treatment, food processing, chemical or pharmaceutical processing, paper pulp processing, and water sanitation.

U.S. Pat. No. 6,251,386 and U.S. Pat. No. 6,818,212 B2 to Johansen relates to an antimicrobial composition containing a haloperoxidase, a hydrogen peroxide source, a halide source and an ammonium source and a method of use of the antimicrobial composition for killing or inhibiting the growth of microorganisms. The patents also describe that there is an unknown synergistic effect between halide and the ammonium source.

U.S. Pat. No. 6,149,908 to Claesson et al. relates to the use of lactoperoxidase, a peroxide donor and thiocyanate for the manufacture of a medicament for treating Helicobacter pylori infection.

U.S. Pat. No. 5,607,681 to Galley et al. describes antimicrobial compositions containing iodide or thiocyanate anions, glucose oxidase and D-glucose, and lactoperoxidase. The patent states that compositions may be provided in concentrated non-reacting forms such as dry powders and non-aqueous solutions. The compositions are mentioned as being useful as preservatives or as active agents providing potent antimicrobial activity of use in oral hygiene, deodorant and anti-dandruff products.

U.S. Pat. No. 5,250,299 to Good et al. relates to a synergistic antimicrobial composition composed of a hypothiocyanate generating system adjusted to a pH between about 1.5 and about 5 with a di or tricarboxylic acid. The hypothiocyanate generating system is composed of lactoperoxidase, a thiocyanate and hydrogen peroxide. The patent describes a method of disinfecting surfaces associated with food preparations, and a method of killing Salmonella on poultry and other Gram negative microorganisms contaminating the surfaces of food products.

U.S. Pat. No. 5,176,899 to Montgomery describes a stabilized aqueous antimicrobial dentifrice composition containing an oxidoreductase enzyme and its specific substrate for producing hydrogen peroxide, a peroxidase acting on the hydrogen peroxide for oxidizing thiocyanate ions contained in saliva to produce antimicrobial concentrations of hypothiocyanite ions.

International Publication No. WO 98/49272 by Guthrie et al. (Knoll Aktiengesellschaft) relates to a stabilized aqueous antimicrobial enzyme composition containing lactoperoxidase, glucose oxidase, alkali metal halide salt, and a chelating buffering agent giving the composition a specified pH. The composition is described as being useful as an antimicrobial agent used in milk products, foodstuffs and pharmaceuticals.

U.S. Pat. No. 5,043,176 to Bycroft et al. relates to a synergistic antimicrobial composition composed of an antimicrobial polypeptide and a hypothiocyanate component. Synergistic activity is seen when the composition is applied at between about 30 and 40° C. at a pH between about 3 and about 5. The composition is said to be useful against gram negative bacteria such as Salmonella. A preferred composition is nisin, lactoperoxidase, thiocyanate and hydrogen peroxide. It is stated that the composition is capable of reducing the viable cell count of Salmonella by greater than 6 logs in 10 to 20 minutes.

U.S. Pat. No. 4,937,072 to Kessler et al. describes an in situ sporicidal disinfectant comprising a peroxidase, a peroxide or peroxide generating materials, and a salt of iodide. The three components are stored in a non-reacting state to maintain the sporocide in an inactive state. By mixing the three components in an aqueous carrier causes a catalyzed reaction by peroxidase to generate antimicrobial free radicals and/or byproducts.

Industrial processes, such as paper-making and pulp processing, use large quantities of water, and it is desirable to inhibit the growth of microorganisms during such processing and in the water inlet and storage facilities for such processes.

Accordingly, it is desirable to have a method of preventing, killing, and/or inhibiting the growth of microorganisms that is inexpensive and uses a composition that is effective at a low concentration and that uses easily available ingredients.

It is also desirable to have a method of preventing, killing, and/or inhibiting the growth of microorganisms that does not use chlorine or other environmentally undesirable ingredients.

### SUMMARY OF THE INVENTION

It has now been found that a potent antimicrobial solution to control growth of microorganisms in aqueous systems and on substrates capable of supporting such growth may be obtained by providing lactoperoxidase (referred to herein as “LP”), hydrogen peroxide or a peroxide source such as percarbonate or enzymatic peroxide generating system such as a glucose oxidase/glucose system (GO/glu), a halide or a thiocyanate, and, optionally, an ammonium source, under conditions wherein the lactoperoxidase, peroxide from the hydrogen peroxide or peroxide source, halide or thiocyanate and ammonium from the ammonium source, if present, interact to provide an antimicrobial agent to the aqueous system or substrate. (An antimicrobial system or solution containing lactoperoxidase as described herein may be referred to herein as an “LP-system” or an “LP antimicrobial system,” interchangeably). The individual components may be pre-mixed to form a solution in water, wherein the components interact to form an antimicrobial agent, and the resulting solution may then be applied in an effective amount to aqueous systems, other systems, or substrates to be treated. Alternatively, the individual components may be added separately (or in any combination) to the aqueous system, other systems, or substrates to be treated, and the concentration of each component can be selected so that an active antimicrobial composition is formed in situ and maintained for a desired period of time in the aqueous systems, other systems, or on a substrate to be treated.

The present invention further provides a composition comprising lactoperoxidase (LP), hydrogen peroxide or a peroxide source such as carbamide peroxide, percarbonate, perborate or persulfate or an enzymatic peroxide generating system such as a glucose oxidase/glucose system (GO/glu), a halide or a thiocyanate, and, optionally, an ammonium source.

The present invention further provides an all-solid composition that contains at least a solid mixture of lactoperoxidase, ammonium bromide, and an enzyme substrate, such as glucose, of an enzyme peroxide generating system in one water-soluble container, and a solid peroxide-generating enzyme, such as glucose oxidase, in another water-soluble container. Alternatively, the all-solid composition in the first-mentioned water-soluble container may be a solid mixture of lactoperoxidase, potassium iodide, and the enzyme substrate or a solid mixture of lactoperoxidase, sodium bromide, ammonium sulfate, and the enzyme substrate. In a further method of the present invention, a potent antimicrobial solution may be formed by dissolving all the solids in the above two water-soluble containers in a desirable amount of water. The resulting solution may then be applied in an effective amount to the systems or substrates to be treated. Alternatively, the contents in the above two water-soluble containers may be dissolved separately in water to form two separate concentrated solutions, one solution containing at least LP, ammonium bromide, and glucose, and the other solution containing at least glucose oxidase. The resulting solutions may then be added separately in an effective amount to the systems or substrates to be treated, wherein the solutions interact in the aqueous system to form the antimicrobial composition.

The LP-system described herein generates a potent antimicrobial composition that is preferably much stronger than hydrogen peroxide acting alone. The present invention can be applied in a variety of industrial fluid systems (e.g., aqueous systems) and processes, including but not limited to, paper-making water systems, pulp slurries, white water in paper-making process, cooling water systems (cooling towers, intake cooling waters and effluent cooling waters), waste water systems, recirculating water systems, hot tubs, swimming pools, recreational water systems, food processing systems, drinking water systems, leather-processing water systems, metal working fluids, and other industrial water systems. The method of the present invention may also be applied to control the growth of microorganisms on various substrates, including, but not limited to, surface coatings, metals, polymeric materials, natural substrates (e.g., stone), masonry, concrete, wood, paint, seeds, plants, animal hides, plastics, cosmetics, personal care products, pharmaceutical preparations, and other industrial materials.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

It is to be understood that both the foregoing general description and the following detailed description are exemplary only and are not restrictive of the present invention, as claimed. All patents, patent applications, and publications mentioned above and throughout the present application are incorporated in their entirety by reference herein.

The accompanying drawings, which are incorporated in and constitute a part of this application, illustrate some of the embodiments of the present invention and together with the description, serve to explain the principles of the present invention.

### BRIEF DESCRIPTION OF THE DRAWINGS

FIG. 1 is a graph comparing the antibacterial efficacy of various lactoperoxidase systems against P. aeruginosa in phosphate buffer (pH 6.0), at various concentrations of H₂O₂.

FIG. 2 is a graph comparing the antibacterial efficacy of H₂O₂ by itself, H₂O₂—NH₄Br and LP—H₂O₂—NH₄Br against P. aeruginosa in phosphate buffer (pH 6.0), at various concentrations of H₂O₂.

FIG. 3 is a graph comparing the antibacterial efficacy of H₂O₂ by itself, H₂O₂—NH₄Br and LP—H₂O₂—NH₄Br against P. aeruginosa in pulp slurry, with an 18 hour treatment time and at various concentrations of H₂O₂.

FIG. 4 is a graph comparing the antibacterial efficacy of H₂O₂ by itself, H₂O₂—KI and LP—H₂O₂—KI against P. aeruginosa in pulp slurry, with an 30 minute treatment time and at various concentrations of H₂O₂.

FIG. 5 is a graph comparing the antibacterial efficacy of LP—NaBO₃—NH₄Br and NaBO₃—NH₄Br against P. aeruginosa in pulp slurry, with an 18 hour treatment time and at various concentrations of NaBO₃.

FIG. 6 is a graph comparing the antibacterial efficacy of LP—NaPerC—NH₄Br and NaPerC—NH₄Br against P. aeruginosa in pulp slurry, with an 18 hour treatment time and at various concentrations of NaPerC.

FIG. 7 is a graph comparing the antibacterial efficacy of LP—CP—NH4Br and CP (carbamide peroxide) only against P. aeruginosa in pulp slurry, with a 24-hr treatment time and at various concentrations of CP.

FIG. 8 is a graph showing the antibacterial efficacy of LP—H₂O₂—NH₄Br against P. aeruginosa in pulp slurry, with a constant concentration of H₂O₂ and NH₄Br and as a function of the concentration of LP.

FIG. 9 is a graph showing the antibacterial efficacy of LP—H₂O₂—NH₄Br against P. aeruginosa in pulp slurry, with a constant concentration of H₂O₂ and LP and as a function of the concentration of NH₄Br.

FIG. 10 is a graph showing the antibacterial efficacy of LP—H₂O₂—NH₄Br against P. aeruginosa in pulp slurry, with a constant concentration of NH₄Br and LP and as a function of the concentration of H₂O₂.

FIG. 11 is a graph comparing the antibacterial efficacy of LP—NH₄Br-GO/Glu and GO/Glu alone against P. aeruginosa in pulp slurry, with a 24 hour treatment time and at various concentrations of GO.

FIG. 12 is a time-kill graph comparing the antibacterial effects of LP—NH₄Br-GO/Glu and GO/Glu alone against P. aeruginosa in pulp slurry.

### DETAILED DESCRIPTION OF THE PRESENT INVENTION

The present invention provides methods and compositions for controlling the growth of microorganisms in aqueous systems or on substrates using a) lactoperoxidase (LP), b) hydrogen peroxide or a hydrogen peroxide source, and c) a halide, plus, optionally, an ammonium source like a salt. The halide and the ammonium source may both be provided in the form of ammonium bromide. For instance, the combination of LP, hydrogen peroxide, and a halide, or the combination of LP, hydrogen peroxide, a halide and an ammonium salt, forms a strong antimicrobial composition that is preferably much more active than hydrogen peroxide working alone. The present invention provides a method for controlling the growth of at least one microorganism in or on a product, material, or medium susceptible to attack by the microorganism. This method includes the step of adding to the product, material, or medium a composition of the present invention in an amount effective to control the growth of the microorganism. The effective amount varies in accordance with the product, material, or medium to be treated and can, for a particular application, be routinely determined by one skilled in the art in view of the disclosure provided herein. The compositions of the present invention are useful in preserving or controlling the growth of at least one microorganism in various types of industrial products, media, or materials susceptible to attack by microorganisms. Such media or materials include, but are not limited to, for example, dyes, pastes, lumber, leathers, textiles, pulp, wood chips, tanning liquor, paper mill liquor, polymer emulsions, paints, paper and other coating and sizing agents, metalworking fluids, geological drilling lubricants, petrochemicals, cooling water systems, recreational water, influent plant water, waste water, pasteurizers, retort cookers, pharmaceutical formulations, cosmetic formulations, and toiletry formulations. The composition can also be useful in agrochemical formulations for the purpose of protecting seeds or crops against microbial spoilage.

The composition preferably provides superior microbicidal activity at low concentrations against a wide range of microorganisms.

The compositions of the present invention can be used in a method for controlling the growth of at least one microorganism in or on a product, material, or medium susceptible to attack by the microorganism. This method includes the step of adding to the product, material, or medium a composition of the present invention, where the components of the composition are present in effective amounts to control the growth of the microorganism.

As stated earlier, the compositions of the present invention are useful in preserving various types of industrial products, media, or materials susceptible to attack by at least one microorganism. The compositions of the present invention are also useful in agrochemical formulations for the purpose of protecting seeds or crops against microbial spoilage. These methods of preserving and protecting are accomplished by adding the composition of the present invention to the products, media, or materials in an amount effective to preserve the products, media, or materials from attack by at least one microorganism or to effectively protect the seeds or crops against microbial spoilage.

According to the methods of the present invention, controlling or inhibiting the growth of at least one microorganism includes the reduction and/or the prevention of such growth.

It is to be further understood that by “controlling” (e.g., preventing) the growth of at least one microorganism, the growth of the microorganism is inhibited. In other words, there is no growth or essentially no growth of the microorganism. “Controlling” the growth of at least one microorganism maintains the microorganism population at a desired level, reduces the population to a desired level (even to undetectable limits, e.g., zero population), and/or inhibits the growth of the microorganism. Thus, in one embodiment of the present invention, the products, material, or media susceptible to attack by the at least one microorganism are preserved from this attack and the resulting spoilage and other detrimental effects caused by the microorganism. Further, it is also to be understood that “controlling” the growth of at least one microorganism also includes biostatically reducing and/or maintaining a low level of at least one microorganism such that the attack by the microorganism and any resulting spoilage or other detrimental effects are mitigated, i.e., the microorganism growth rate or microorganism attack rate is slowed down and/or eliminated.

Examples of these microorganisms include fungi, bacteria, algae, and mixtures thereof, such as, but not limited to, for example, Trichoderma viride, Aspergillus niger, Pseudomonas aeruginosa, Klebsiella pneumoniae, and Chlorella sp. The compositions of the present invention have a low toxicity.

Lactoperoxidase is a glycoprotein with one non-covalently bound heme group. It is part of the non-immune defense system in milk and is present in milk in concentrations of about 30 mg/L. It is also present in various body fluids, such as saliva, tears, and nasal and intestinal secretions.

LP differs from haloperoxidase in that it is an enzyme that can be derived from bovine milk as a natural product from dairy industry, whereas haloperoxidase is an enzyme that is obtained from fungi or bacteria by fermentation or by recombinant DNA technology. Another difference between LP and haloperoxidase is that haloperoxidase can catalyze the oxidation of Cl⁻, while LP cannot. LP is currently available on an industrial scale and in a very purified form, while haloperoxidase is only available in quantities on an experimental scale. Therefore, LP is less expensive than haloperoxidase. Therefore, the major advantages of LP over haloperoxidase are its availability in larger scale and its relatively low cost compared to haloperoxidase.

Although lactoperoxidase has no antimicrobial activity by itself, in the presence of H₂O₂, it catalyzes the oxidation of Br⁻, I⁻, or SCN⁻, but not Cl⁻, to generate antimicrobial products. LP, H₂O₂, and oxidizable substrates such as Br⁻, I⁻, or SCN⁻ together form potent antimicrobial systems. The antimicrobial efficacy of lactoperoxidase antimicrobial systems (“LP antimicrobial systems”) is mediated by the generation of oxidation products of Br⁻, I⁻, or SCN⁻, mainly the hypohalides and hypothiocyanates. LP antimicrobial systems require very low levels of H₂O₂ and electron donors for producing antimicrobial products. As described herein, the addition of an ammonium ion further enhances the antimicrobial activity when included in an LP antimicrobial system. In particular, the combination of lactoperoxidase, peroxide or a peroxide source, and ammonium bromide provides a particularly useful and economical antimicrobial system.

The lactoperoxidase of the present invention may be obtained from any mammalian source such as mammalian milk, particularly bovine milk. Further, lactoperoxidase is readily available from commercial sources. The lactoperoxidase may be in the form of a dry powder or may be in an aqueous solution. In a typical commercial form, LP is a greenish-brown powder, containing more than 90% protein. The enzyme demonstrates a broad pH-stability profile (pH 3-10) with an optimal pH of 5.0-6.5. The enzyme may be stored at room temperature. In an original sealed package, such as may be obtained from a commercial source, LP has a shelf life of at least 1 year at 20° C. and 2 years at 8° C. Exposure of the enzyme to elevated temperature (>65° C.) for short time (10 minutes) results in denaturation of the protein and loss of the activity.

The hydrogen peroxide (which may be considered the peroxide source) used in the LP antimicrobial system of the present invention may be derived in many different ways: It may be a concentrated or a diluted hydrogen peroxide solution, or it may be obtained from a hydrogen peroxide precursor, such as percarbonate, perborate, carbamide peroxide (also called urea hydrogen peroxide), or persulfate. It may be obtained from an enzymatic hydrogen peroxide generating system, such as glucose oxidase coupled with glucose or amylase/starch (which generates glucose) plus glucose oxidase. Other enzyme/substrate combinations that generate hydrogen peroxide may be used. It is advantageous to use enzymatic-generated hydrogen peroxide, since all materials involved are environmentally green. It is much easier to transport and handle these materials than hydrogen peroxide itself.

The halide used in the LP antimicrobial system of the present invention may be obtained from any halide source or generating source and can be from many different sources. It can be ammonium bromide, sodium bromide, potassium bromide, calcium bromide, magnesium bromide, sodium iodide, potassium iodide, ammonium iodide, calcium iodide, and/or magnesium iodide. It can be any halide salts of alkaline metals or alkaline earth metals. In the LP antimicrobial system of the present invention, chloride compounds are preferably excluded as a halide source, since lactoperoxidase does not catalyze the oxidation of Cl⁻. Thiocyanates, such as sodium thiocyanate, ammonium thiocyanate, potassium thiocyanate can also be used as the electron donor instead of a halide in the LP antimicrobial system.

The ammonium that may be used in the LP antimicrobial system to provide additional synergistic antimicrobial effects according to the present invention may be obtained from any ammonium source. The ammonium source can be an ammonium salt. As a non-limiting example, both the halide and the ammonium may be provided by an ammonium halide, such as ammonium bromide (NH₄Br). As a further non-limiting example, the halide and the ammonium may be provided by sodium bromide and ammonium sulfate, respectively. As a further non-limiting example, the halide may be potassium iodide and the ammonium source may be omitted.

As a method of killing, or preventing, or inhibiting the growth of microorganisms in an aqueous system or on a substrate that is capable of supporting a growth of microorganisms, the lactoperoxidase, hydrogen peroxide or a peroxide source, halide or thiocyanate, and, optionally, an ammonium source, may be provided to the aqueous system or substrate that is capable of supporting a growth of microorganisms under conditions wherein the lactoperoxidase, peroxide from the hydrogen peroxide or peroxide source, halide or thiocyanate and ammonium from the ammonium source (if present) interact to provide an antimicrobial agent that kills, or prevents, or inhibits the growth of microorganisms in the aqueous system or on the substrate.

One of ordinary skill can readily determine the effective amount of the various compositions of the present invention useful for a particular application by simply testing various concentrations prior to treatment of an entire affected substrate or system. For instance, in an aqueous system to be treated, the concentration of lactoperoxidase may be any effective amount, such as in a range of about 0.01 to about 1000 ppm, and is preferably in a range of from about 0.1 to about 50 ppm.

The peroxide source may be present in the aqueous system in any effective amount, such as in a sufficient amount to provide a concentration of hydrogen peroxide in the aqueous system in a range of about 0.01 to about 1000 ppm, and preferably in the range of about 0.1 to about 200 ppm.

The halide or thiocyanate may be present in the aqueous system in any effective amount, such as at a concentration in the aqueous system in a range of about 0.1 to about 10000 ppm, and preferably in the range of about 1 to about 500 ppm.

The ammonium source may be present in the aqueous system in any effective amount, such as in a sufficient concentration to provide an ammonium ion concentration in the aqueous system in a range of from 0.0 to about 10000 ppm or in a range of about 0.1 to about 10000 ppm, and preferably in the range of about 0 to about 500 ppm or in a range of about 1 to about 500 ppm.

The concentrations of the components of an LP antimicrobial system, such as lactoperoxidase, hydrogen peroxide, halide or thiocyanate and ammonium as described above or as described elsewhere in this application, may be the initial concentrations of the components at the time that the components are combined or added to an aqueous system and/or may be the concentrations of the components at any time after the components have interacted with each other.

The present invention also embodies the separate addition of the components of the composition to products, materials, or media. According to this embodiment, the components are individually added to the products, materials, or media so that the final amount of each component present at the time of use is that amount effective to control the growth of at least one microorganism. According to an aspect of the present invention, the lactoperoxidase, hydrogen peroxide or a peroxide source, halide or thiocyanate, and optional ammonium source may be added separately to an aqueous system to be treated. For example, a halide and, optionally, an ammonium source may be added first to aqueous system to be treated, then the lactoperoxidase may be added, finally the hydrogen peroxide may be added. The order of component addition is not critical and any order can be use. Preferably, the order of addition is 1) halide/ammonium, 2) LP, and 3) hydrogen peroxide or other peroxide source.

According to another aspect of the present invention, the components of an LP antimicrobial system as described herein can be pre-mixed in water to form a concentrated aqueous solution. The concentrated aqueous solution may then be applied to an aqueous system or substrate to be treated. The concentration of the lactoperoxidase, hydrogen peroxide or a peroxide source, halide or thiocyanate, and optional ammonium source may be selected to optimize the antimicrobial activity of the LP antimicrobial system.

The concentration of LP in the pre-mixed solution may be in the range of about 0.01 wt % to about 5 wt %, with a preferred range of from about 0.05 wt % to about 0.5 wt %. All wt % herein are by weight of the solution pre-mixed. The peroxide source may be present in the pre-mixed solution in a sufficient amount to provide a concentration of hydrogen peroxide in the pre-mixed solution in a range of from about 0.03 wt % to about 15 wt %, with a preferred range of from about 0.15 wt % to about 1.5 wt %. The halide or thiocyanate source may be present in the pre-mixed solution in a sufficient concentration to provide a halide or thiocyanate concentration in the pre-mixed solution in a range of from about 0.1 wt % to about 50 wt %, with a preferred range of from about 0.5 wt % to about 5 wt %. The ammonium source may be present in the pre-mixed solution in a sufficient concentration to provide an ammonium concentration in the pre-mixed solution in a range of from 0.0 wt % to about 50 wt % or from about 0.1 wt % to about 50 wt %, with a preferred range of from about 0.0 wt % to about 5 wt % or from about 0.5 wt % to about 5 wt %.

As an example, lactoperoxidase, ammonium bromide, hydrogen peroxide, and water may be combined (e.g., mixed) to form an active concentrated antimicrobial solution. All wt % herein are by weight of the antimicrobial solution. In the concentrated antimicrobial solution, the lactoperoxidase may be in the range of from about 0.01 wt % to about 5 wt %, with a preferred range of from about 0.05 wt % to about 0.5 wt %, the hydrogen peroxide may be in a range of from about 0.03 wt % to about 15 wt %, with a preferred range of from about 0.15 wt % to about 1.5 wt % and the ammonium bromide in a range of from about 0.1 wt % to about 50 wt %, with a preferred range of from about 0.5 wt % to about 5 wt %. The weight ratio of LP:H₂O₂:NH₄Br may range from about 1:1:5 to about 1:10:100, with a preferable weight ratio of about 1:3:10. The concentrated solution may be applied to an aqueous system or a substrate to be treated.

The mixing of the components of a LP antibacterial system as a pre-mixed concentrated solution may be achieved by any method that is known in the art. For example, the bromide salt and lactoperoxidase may be added as solids to water to form a solution, then a hydrogen peroxide solution may be added to form the final composition. Alternatively, an aqueous solution of bromide salt may be prepared first and a solid LP may be added later, and then a hydrogen peroxide solution. Alternatively, if the hydrogen peroxide source is a solid precursor such as a percarbonate or perborate or an enzymatic H₂O₂ generating system, the components of the LP antimicrobial system may be added to water in solid form.

As still another alternative, the components of a LP antimicrobial system may be combined as solutions. For example, an aqueous ammonium bromide solution and an aqueous LP solution may be combined to form a mixed solution of LP/NH₄Br, and then an aqueous H₂O₂ solution may be added. The aqueous H₂O₂ solution can be derived either from diluting a concentrated H₂O₂ solution or by dissolving a solid H₂O₂ precursor such as a percarbonate or perborate or an enzymatic H₂O₂ generating system in water. This alternative provides an easy way of treating an aqueous system or a substrate. An aqueous ammonium bromide solution and an aqueous LP solution may be prepared in separate tanks and then combined in the desired amounts in a mixing tank to form an inactive solution of LP/NH₄Br, which can be stored. When an antimicrobial agent is needed, the solution of LP/NH₄Br can be combined with an aqueous H₂O₂ solution to form an active antimicrobial solution to be used. It is preferred to prepare a mixed solution of LP/NH₄Br in a single tank, and then add H₂O₂ solution to activate the LP-antimicrobial system.

The present invention further provides for an all-solid composition in which the components of an LP-antimicrobial system can be stored and maintained in a non-reactive state and then combined with water when needed to form an antimicrobial agent. For example, for an antimicrobial system comprising lactoperoxidase, a halide source, an optional ammonium source and an enzymatic hydrogen peroxide generating system, such as glucose oxidase coupled with glucose or amylase/starch plus glucose oxidase, a solid mixture of lactoperoxidase, the halide source, the optional ammonium source and the substrate for the enzymatic hydrogen peroxide generating system can be stored in one container and the enzyme for the enzymatic hydrogen peroxide generating system can be stored separately in another container. If water-soluble containers are used, an antimicrobial agent can be produced by combining the containers with water to dissolve the components therein to form a concentrated solution, or by adding the containers directly to an aqueous system. Alternatively, the containers can be added separately to an aqueous system to be treated.

As a specific example, a solid mixture of lactoperoxidase, ammonium bromide, and glucose may be provided in one water-soluble bag or container, and a solid glucose oxidase may be provided in another water-soluble bag or container. Dissolving all of the solids in the above two water-soluble bags in a desirable amount of water forms a potent antimicrobial solution. The resulting solution may then be applied in an effective amount to an aqueous system or substrate to be treated. Alternatively, both bags could be added directly to an aqueous system to be treated, or the two bags could be added separately to the aqueous system. As another specific example, instead of two separate containers for storing the solid components, one single container having separate chambers could be used, as long as there is sufficient separation so that the components of the LP antimicrobial system are kept in a solid and inactive form before they are exposed to water. For example, one chamber could contain a solid mixture of lactoperoxidase, ammonium bromide, and glucose and the other chamber could contain a solid glucose oxidase. It is preferred to keep all of the ingredients of the LP antimicrobial system in a non-reacting form before mixing with water. Preferably, in a storage system wherein glucose oxidase is kept separately in solid form, the glucose oxidase can be kept in an anaerobic condition so that oxygen is physically separated from the glucose oxidase, thereby maintaining the glucose oxidase in a substantially non-reacting form.

In an all-solid composition of the LP antimicrobial system comprising glucose oxidase, lactoperoxidase, ammonium bromide and glucose (with glucose oxidase stored separately from the other components), the weight ratio for the four components, glucose oxidase: LP: NH4Br: glucose, may be in a range of about 1:1:10:100 to about 1:5:100:5000, with a preferable weight ratio of about 1:4:100:2000.

Depending upon the specific application, the composition can be prepared in liquid form by dissolving the composition in water or in an organic solvent, or in dry form by adsorbing onto a suitable vehicle, or compounding into a tablet form. The preservative containing the composition of the present invention may be prepared in an emulsion form by emulsifying it in water, or if necessary, by adding a surfactant. Additional chemicals, such as insecticides, may be added to the foregoing preparations depending upon the intended use of the preparation.

The mode as well as the rates of application of the composition of this invention could vary depending upon the intended use. The composition could be applied by spraying or brushing onto the material or product. The material or product in question could also be treated by dipping in a suitable formulation of the composition. In a liquid or liquid-like medium, the composition could be added into the medium by pouring, or by metering with a suitable device so that a solution or a dispersion of the composition can be produced.

For example, a concentrated antimicrobial solution can be derived from the all-solid solution described above by dissolving the glucose oxidase, lactoperoxidase, ammonium bromide and glucose in water. The resulting solution may then be applied to an aqueous system or a substrate to be treated. In an aqueous system, the components of the LP antimicrobial system may be added separately or in a pre-mixed solution to provide the system with the following effective amounts:
(a) LP: from about 0.01 to about 1000 ppm, preferably in the range of from about 0.1 to about 50 ppm.
(b) NH₄Br: from about 0.1 to about 10000 ppm, preferably in the range of from about 1 to about 500 ppm.
(c) Glucose Oxidase: from about 0.01 to about 500 ppm, preferably in the range of from about 0.05 to about 50 ppm.
(d) Glucose: from about 1 to about 10000 ppm, preferably in the range of from about 10 to about 5000 ppm.

As a further specific, non-limiting example, the LP antimicrobial system may comprise LP, a peroxide source, potassium iodide, and an optional ammonium source. As an even more specific, non-limiting example, the LP antimicrobial system may comprise LP, H₂O₂ and KI. The amounts of each component may be as described generally above for the amounts of LP, peroxide source, halide source and optional ammonium source for an LP antimicrobial system. In particular, the amount of KI used in an LP antimicrobial system containing KI may be the same as the amount of NH₄Br in an LP antimicrobial system containing NH₄Br as described above. Such an LP antimicrobial system containing KI may be in any of the physical forms described above for an LP antimicrobial system.

As a further specific, non-limiting example, the LP antimicrobial system may comprise LP, a peroxide source, sodium bromide, and ammonium sulfate. The amounts of each component may be as described generally above for the amounts of LP, peroxide source, halide source and optional ammonium source for an LP antimicrobial system. In particular, the amount of NaBr and (NH₄)₂SO₄ used in an LP antimicrobial system containing NaBr and (NH₄)₂SO₄ may be selected to provide the same amount of NH₄ and Br as is provided in an LP antimicrobial system containing NH₄Br as described above. Such an LP antimicrobial system containing NaBr and (NH₄)₂SO₄ may be in any of the physical forms described above for an LP antimicrobial system.

The method of the present invention may be practiced at any pH, such as a pH range of from about 2 to about 11, with a preferable pH range of from about 5 to about 9. The pH of the pre-mixed solution of the LP antimicrobial system may be adjusted by adding an acid(s) or a base(s) as is known in the art. The acid or base added should be selected to not react with any components in the system. However, it is preferable to mix the components of the LP system in water without pH adjustment. The pH of a pre-mixed solution of LP—H₂O₂—NH₄Br without pH adjustment is around 6.9. At a pH around neutral (7.0), the LP antimicrobial system produces the maximum activity.

The method of the present invention may be used in any industrial or recreational aqueous systems requiring microorganism control. Such aqueous systems include, but are not limited to, metal working fluids, cooling water systems (cooling towers, intake cooling waters and effluent cooling waters), waste water systems including waste waters or sanitation waters undergoing treatment of the waste in the water, e.g. sewage treatment, recirculating water systems, swimming pools, hot tubs, food processing systems, drinking water systems, leather-processing water systems, white water systems, pulp slurries and other paper-making or paper-processing water systems. In general, any industrial or recreational water system can benefit from the present invention. The method of the present invention may also be used in the treatment of intake water for such various industrial processes or recreational facilities. Intake water can be first treated by the method of the present invention so that the microbial growth is inhibited before the intake water enters the industrial process or recreational facility.

The method of the present invention may also be applied to prevent or inhibit the growth of microorganisms on any substrate that is otherwise capable of supporting such growth. Examples of substrates include, but are not limited to, surface coatings, wood, metal, polymer, natural (e.g., stone), masonry, cement, lumber, seeds, plants, leather, plastics, cosmetics, personal care products, pharmaceutical preparations, and other industrial materials. In addition, substrates include hard surfaces in aqueous systems, food processing plants and hospitals and on paper-making equipment and agricultural equipment.

The present invention will be further clarified by the following examples, which are intended to be exemplary of the present invention.

### EXAMPLES

### Example 1

### Antibacterial Efficacy of Various Lactoperoxidase Systems Against P. aeruginosa in Phosphate Buffer (pH 6.0)

LP, H₂O₂, and either KI, NH₄Br, NaSCN or NaBr as electron donors were added separately to a phosphate buffer in test tubes at desired concentrations to form various LP antimicrobial systems. The buffer was then inoculated with 3×10⁶ cells/ml of P. aeruginosa. At a contact (or treatment) time of 4 hours after inoculation, 1.0 ml liquid was withdrawn from the test tube and plated on nutrient agar to 10⁻², 10⁻³, and 10⁴ dilutions using biocide deactivation solution as the dilution blanks. The agar plates were incubated at 37° C. for 2-3 days, and the colonies were counted. Percent kill and log reduction were calculated based on cfu/ml of the control culture. The control culture contained bacterial cells in 5 ml phosphate buffer only.

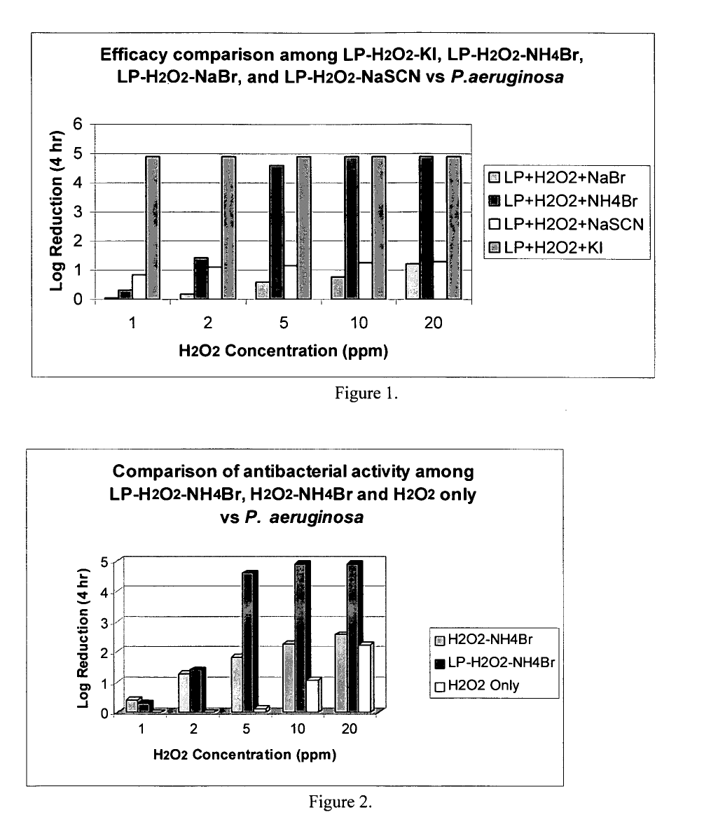

FIG. 1 summarizes the bactericidal activities of the LP-systems with different electron donors against P. aeruginosa in phosphate buffer (pH 6) with a 4 hour treatment time as described above. The LP concentration was 200 ppm for all systems and the concentration of each individual electron donor was 0.02 M. The H₂O₂ concentration was varied, as shown in the FIG. 1. As can be seen from the results, LP combined with H₂O₂ and an electron donor such as KI, NH₄Br, or NaSCN formed potent antimicrobial LP-systems. The antimicrobial activity varied as different electron donors were used in the system. The results show that the LP—H₂O₂—KI system was the strongest in terms of activity among the tested LP-systems. The next strong antimicrobial system was LP—H₂O₂—NH₄Br, which provided greater than 4.5 logs reduction when H₂O₂ concentration was 5 ppm and above. The showing that the LP—H₂O₂—NH₄Br system had comparable results to the LP—H₂O₂—KI system at an H₂O₂ concentration above 5 ppm is significant since NH₄Br is much less expensive than KI and is a widely available material. Accordingly, the LP—H₂O₂—NH₄Br system has a great potential for developing an enzyme based antimicrobial system for various industries. The other two systems, namely LP—H₂O₂—NaBr and LP—H₂O₂—NaSCN, did not generate results as good as the LP—H₂O₂—NH₄Br system with respect to efficacy. Their activities were about the same or worse than the activity of H₂O₂ alone (see FIG. 2). In particular, in comparing the results of the LP—H₂O₂—NH₄Br system with the results of the LP—H₂O₂—NaBr system, the data show a dramatic improvement when NH₄Br is used instead of NaBr.

As a comparison, a test using H₂O₂ alone in buffer without the addition of an electron donor and enzyme and a test using H₂O₂ and NH₄Br without the enzyme were carried out against P. aeruginosa in phosphate buffer (pH 6) with a 4 hour treatment time. As described above, the LP concentration for the LP—H₂O₂—NH₄Br system was 200 ppm. The NH₄Br concentration was 0.02 M for both the LP—H₂O₂—NH₄Br and the H₂O₂—NH₄Br systems. The H₂O₂ concentration was varied as shown in FIG. 2. FIG. 2 shows a clear advantage of the LP—H₂O₂—NH₄Br system over H₂O₂—NH₄Br and H₂O₂ alone. In particular, the addition of LP to H₂O₂—NH₄Br results in an increase in activity of more than 2 logs as compared with the activity of H₂O₂—NH₄Br without the enzyme. It is assumed that the enzyme helps to push the reaction of H₂O₂+NH₄Br->Br⁺(HOBr)+NH₂Br+H₂O towards the right hand side, thus generating more and stronger antimicrobial products.

### Example 2

### Antibacterial Efficacy of Various Lactoperoxidase Systems Against P. aeruginosa in Pulp Slurry

The components of the LP-systems were added separately to pulp slurry to form various LP antimicrobial systems. A test procedure similar to that described in Example 1 was used for the present evaluation. The only modification was using pulp slurry to replace the phosphate buffer. The pulp slurry contained white bleached dry pulp at 5 g/L; cationic starch at 0.025 g/L; CaCO₃ at 0.75 g/L; ASA size at 0.01 g/L; retention aids at 0.0025 g/L; defoamer at 0.0012 g/L. The pulp slurry had a consistency of about 0.5 to 0.7% of solids. The final pH of the pulp slurry after autoclave was about 7.5-8.0.

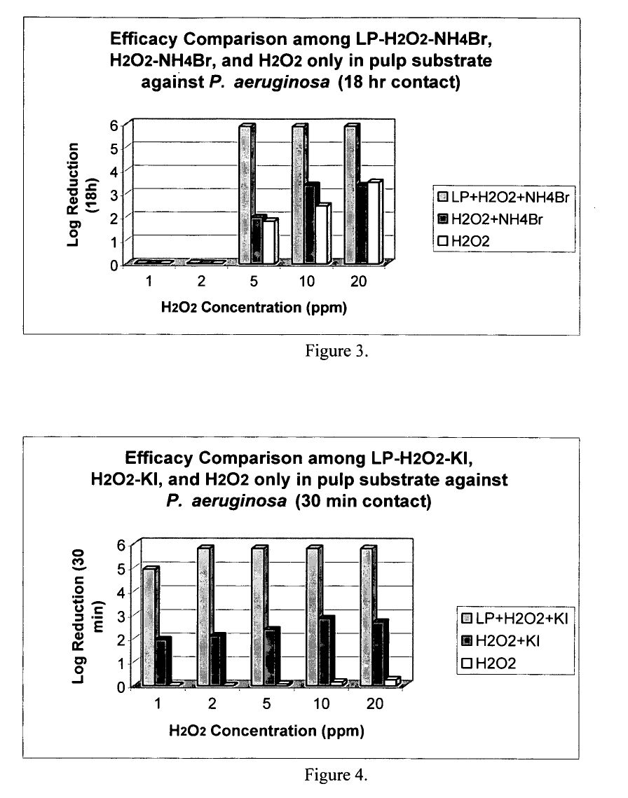

The antibacterial activity of the LP—H₂O₂—NH₄Br system, compared with the activity of H₂O₂—NH₄Br, and H₂O₂ only, against P. aeruginosa in pulp slurry with an 18 hour treatment time is shown in FIG. 3. The LP concentration was 200 ppm. The NH₄Br concentration was 1000 ppm for both LP—H₂O₂—NH₄Br and H₂O₂—NH₄Br systems and the H₂O₂ concentration was varied as shown. FIG. 3 shows that the LP—H₂O₂—NH₄Br system produced a greater than 5.8 logs reduction within 18 hours when the H₂O₂ concentration was 5 ppm or above. The addition of LP dramatically increased the activity of the system as compared with the activity of H₂O₂—NH₄Br without the enzyme or H₂O₂ alone. The results of the LP—H₂O₂—NH₄Br system in pulp slurry were consistent with those obtained in phosphate buffer (in Example 1).

A similar test procedure was carried out to compare the antibacterial activity of a LP—H₂O₂—KI system, compared with the activity of H₂O₂—KI, and H₂O₂ only against P. aeruginosa in pulp slurry with a 30 minute treatment time. The LP concentration was 200 ppm. The KI concentration was 1000 ppm for both the LP—H₂O₂—KI system and the H₂O₂—KI system. FIG. 4 show that the LP—H₂O₂—KI system generated a stronger activity in a shorter time and lower peroxide concentrations (1-2 ppm) than the LP—H₂O₂—NH₄Br system.

### Example 3

### Effectiveness of Perborate, Percarbonate, and Carbamide Peroxide as Oxidizers in an LP Antimicrobial System

To test the effectiveness of sodium perborate, sodium percarbonate, and carbamide peroxide for the generation of antibacterial activity in LP systems, NH₄Br was used as the electron donor.

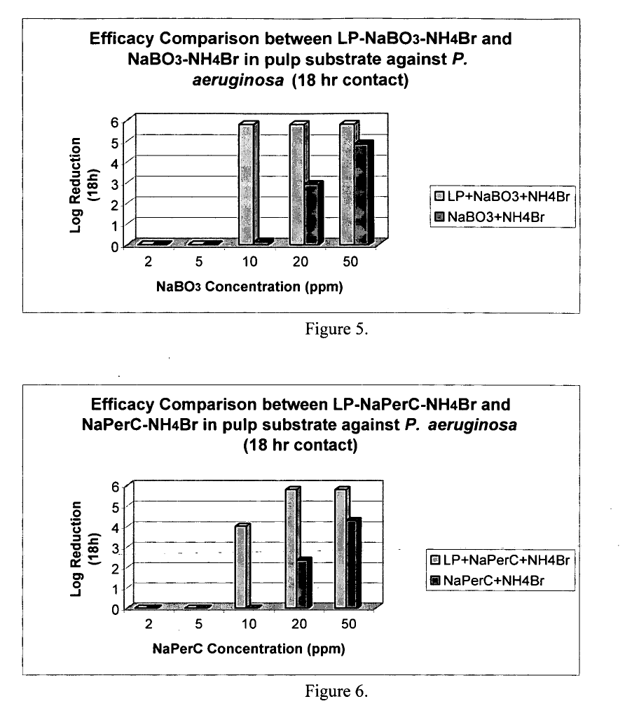

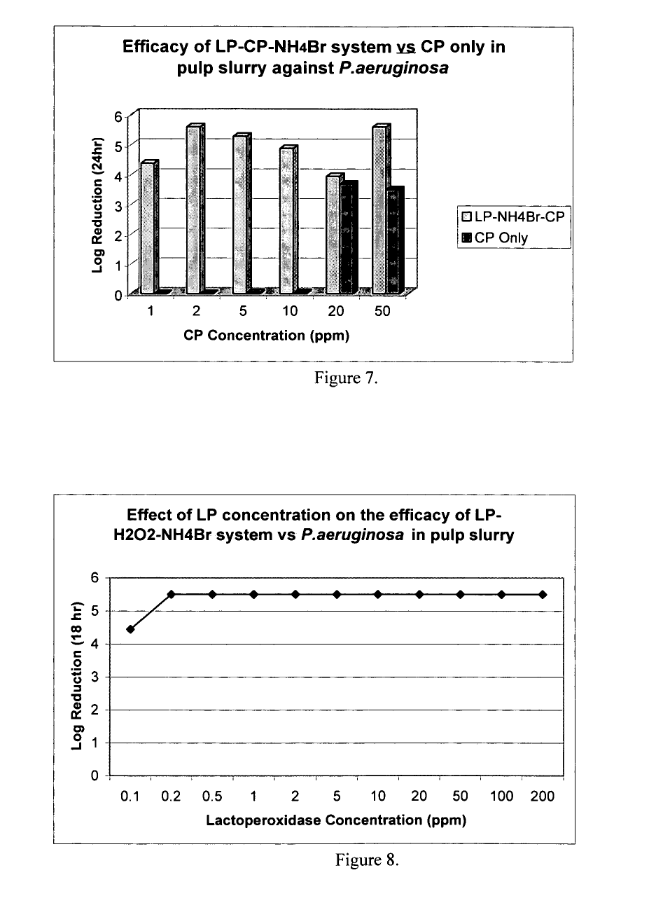

The oxidizers, LP, and NH₄Br were added separately to a pulp slurry. The test procedure was the same as that described in Example 2. FIGS. 5, 6, and 7 illustrate the antibacterial activities of LP systems with perborate (NaBO₃), percarbonate (NaPerC), and carbamide peroxide (CP) as the oxidizer. FIG. 5 shows the antibacterial activity of the LP—NaBO₃—NH₄Br system, compared with the activity of NaBO₃—NH₄Br alone against P. aeruginosa in pulp slurry with an 18 hour treatment time. The LP concentration was 200 ppm and the NH₄Br concentration was 1000 ppm. The NaBO₃ concentration was varied as shown. FIG. 6 shows the antibacterial activity of the LP—NaPerC—NH₄Br system, compared with the activity of NaPerC—NH₄Br alone against P. aeruginosa in pulp slurry with an 18 hour treatment time. The LP concentration was 200 ppm and the NH₄Br concentration was 1000 ppm. The NaPerC concentration was varied as shown. FIG. 7 shows the antibacterial activity of the LP—CP—NH₄Br system, compared with the activity of CP alone against P. aeruginosa in pulp slurry with an 24 hour treatment time. The LP concentration was 2 ppm and the NH₄Br concentration was 60 ppm. The CP concentration was varied as shown. The systems with perborate and percarbonate generated similar levels of activity as compared to the system with hydrogen peroxide, but at a higher oxidizer concentration. For the systems of LP—NaBO₃—NH₄Br and LP—NaPerC—NH₄Br, the activity started to show up at 10 ppm of perborate or percarbonate (FIGS. 5 and 6), whereas the activity started at 5 ppm of H₂O₂ for the system of LP—H₂O₂—NH₄Br (FIG. 3). This can be explained by the fact that sodium percarbonate contains only about 25% hydrogen peroxide by weight. The system of LP—CP—NH₄Br started to generate strong activity at 1-2 ppm of carbamide peroxide (FIG. 7). The LP—CP—NH₄Br system uses a much lower oxidizer concentration to produce strong activity than the other three systems, namely LP—NaBO₃—NH₄Br (FIG. 5), LP—NaPerC—NH₄Br (FIG. 6), and LP—H₂O₂—NH₄Br (FIG. 3). This is because much lower concentrations of LP (2 ppm) and NH₄Br (60 ppm) were used for LP—CP—NH₄Br system than for the other three systems, where 200 ppm of LP and 1000 ppm of NH₄Br were used. The concentrations of LP and NH₄Br in the other three systems were not optimized, thus the excess amounts of LP and NH₄Br could consume a portion of H₂O₂ in the systems. The following example 4 will discuss the optimization of LP-systems.

### Example 4

### Optimal Component Concentrations of LP-System by Separate Addition

To determine the optimum concentration of each component in the LP—H₂O₂—NH₄Br system, the concentration of one component was changed while keeping the concentrations of the other two components at an excess amount. For example, to determine the optimum concentration of lactoperoxidase, the H₂O₂ concentration was kept at 5 ppm and the NH₄Br concentration at 1000 ppm while changing the LP concentration from 0.1 to 200 ppm. To determine the optimum NH₄Br concentration, the H₂O₂ concentration was kept at 5 ppm and the LP concentration at 200 ppm while changing the NH₄Br concentration from 1 to 200 ppm. To determine the optimum H₂O₂ concentration, the NH₄Br concentration was kept at 100 ppm and the LP concentration at 1 ppm, while changing the H₂O₂ concentration from 0.1 to 5 ppm. The test procedure for evaluating the antibacterial efficacy of the LP-system is described in Examples 1 and 2.

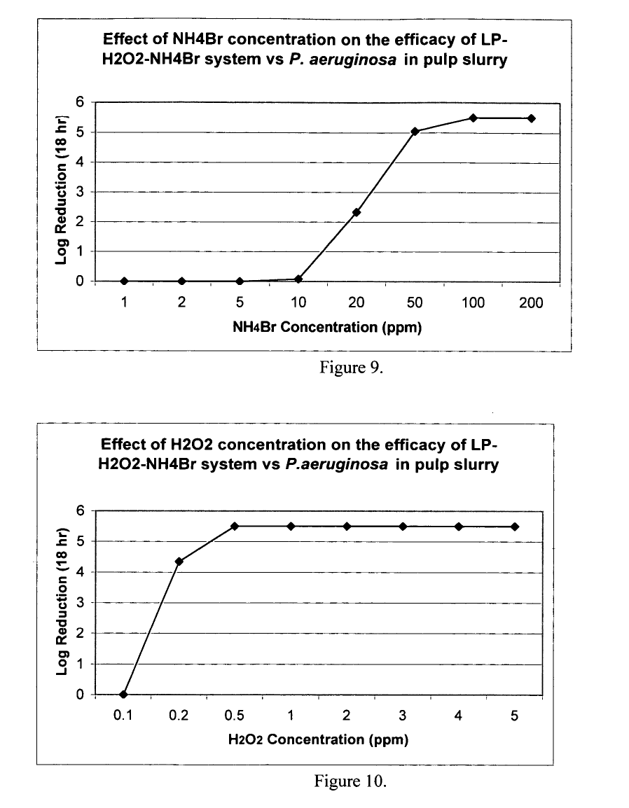

Data in Example 2 indicate that the antimicrobial system of LP—H₂O₂—NH₄Br achieved greater than 5.5 logs reduction of Ps. aeruginosa when providing 200 ppm of LP, 5 ppm of H₂O₂, and 1000 ppm of NH₄Br in the combination. It was assumed that all three components (especially LP and NH₄Br) in the system were in an excess amount during the previous evaluation. To determine the minimum effective concentration (for producing >5 logs reduction) of each individual component, the concentration of that component was varied while keeping the other two components in excess in the combination, as described above. FIG. 8 shows the antibacterial activity of the LP—H₂O₂—NH₄Br system versus LP concentration. In the test, the concentrations of H₂O₂ (5 ppm) and NH₄Br (1000 ppm) were kept in excess, while the LP concentration was varied from 0.1 ppm to 200 ppm. Data in FIG. 8 indicate that the LP—H₂O₂—NH₄Br system yielded greater than 5 logs reduction as long as the LP concentration was equal or above 0.2 ppm. At 0.1 ppm of LP the system achieved 4.4 logs reduction. Therefore, it was concluded that the minimum effective concentration of LP to achieve >5 logs reduction is 0.2 ppm. Similarly, it was determined that the minimum effective concentration of NH₄Br was 50 ppm (FIG. 9). Further increases in NH₄Br concentration beyond 50 ppm did not result in a significant improvement in efficacy of the system. Also, the minimum effective concentration to achieve >5 logs reduction for H₂O₂, was found to be 0.5 ppm as illustrated in FIG. 10. Further increases in H₂O₂ concentration to above 0.5 ppm failed to improve the activity of the system. The minimum effective concentration for individual components is considered as the lowest concentration in the combination to achieve maximum activity of the system. Further increase in concentration beyond the minimum effective concentration would not help improving the antimicrobial activity of the system significantly, and thus considered in excess.

FIGS. 8, 9, and 10 demonstrate that the minimum effective concentrations to achieve >5 logs reduction for each individual component namely LP, H₂O₂, and NH₄Br are 0.2, 0.5, and 50 ppm, respectively. These minimum effective concentrations for the individual components are derived by keeping the other two components in excess in the combination during the tests. From Table 1, the optimal combination for the system was found to be LP=1 ppm/H₂O₂=1 ppm/NH₄Br=40 ppm. With the optimal combined concentrations, the LP—H₂O₂—NH₄Br system gave >5.5 logs reduction. The ratio of three components for this system was LP: H₂O₂: NH₄Br=1: 1: 40 by weight. Several other combinations in Table 1 could be also considered as an optimal combination. They are (1) LP: H₂O₂: NH₄Br=0.5: 0.5: 60, (2) LP: H₂O₂: NH₄Br=0.5: 1: 60.

TABLE 1
Antibacterial activity of LP-H₂O₂—NH₄Br system
against P. aeruginosa in pulp slurry at various concentration
combinations (18 hr treatment time)

| Combination of three | | | |
|---|---|---|---|
| components (separate addition) | | | |
| LP (ppm) | H₂O₂ (ppm) | NH₄Br (ppm) | Log Reduction |
| 0.2 | 0.5 | 20 | 0.0 |
| 0.2 | 0.5 | 40 | 0.06 |
| 0.2 | 0.5 | 50 | 1.10 |
| 0.2 | 0.5 | 60 | 1.11 |
| 0.2 | 0.5 | 80 | 1.36 |
| 0.5 | 0.5 | 20 | 0.30 |
| 0.5 | 0.5 | 40 | 2.91 |
| 0.5 | 0.5 | 50 | 3.42 |
| 0.5 | 0.5 | 60 | >5.5 |
| 0.5 | 0.5 | 80 | >5.5 |
| 0.5 | 1 | 20 | 0.00 |
| 0.5 | 1 | 40 | 2.51 |
| 0.5 | 1 | 50 | 3.87 |
| 0.5 | 1 | 60 | >5.5 |
| 0.5 | 1 | 80 | >5.5 |
| 1 | 1 | 20 | 4.63 |
| 1 | 1 | 40 | >5.5 |
| 1 | 1 | 50 | >5.5 |
| 1 | 1 | 60 | >5.5 |
| 1 | 1 | 80 | >5.5 |
| 1 | 2 | 20 | 2.04 |
| 1 | 2 | 40 | 4.58 |
| 1 | 2 | 50 | >5.5 |
| 1 | 2 | 60 | >5.5 |
| 1 | 2 | 80 | >5.5 |

### Example 5

### LP Antimicrobial System by Pre-Mixing

LP antimicrobial systems can be generated in situ by adding the components separately to the application site. Alternatively, LP-systems can be produced by pre-mixing all of the components in a concentrated solution. The mixed solution may then be applied to the site to by treated. The following example shows the generation of a LP—H₂O₂—NH₄Br antimicrobial system by pre-mixing.

A typical pre-mixed solution of LP—H₂O₂—NH₄Br was prepared as the following. 0.05 g of LP and 0.5 g of NH₄Br were added in a 1-oz glass bottle. 10 ml DI water was added to the bottle to dissolve all of the contents. Then 0.5 g of 30% H₂O₂ was added to the bottle to make a solution containing the 3 components mixed together. This mixed solution contained (w/v) 0.5% LP, 1.5% H₂O₂, and 5% NH₄Br. The weight ratio of this solution was 1:3:10 as LP:H₂O₂:NH₄Br. Mixed solutions with other ratios and concentrations were prepared accordingly. Immediately after the solution was made (considered as 0 hr), 10 μl of the above mixed solution was added to 10 mL pulp slurry to give final concentrations in pulp slurry of 5 ppm of LP, 15 ppm of H₂O₂, and 50 ppm of NH₄Br. A microbiological test was conducted using the procedure described in Example 2, and the antibacterial test for the mixed solution was repeated at 1, 2, 4, 6, and 8 hours after mixing.

In order to test how long the efficacy of a LP/H₂O₂/NH₄Br mixture can hold in an aqueous solution, the three components were mixed together in DI water and the mixed solutions were tested for antibacterial activity in pulp slurry at different times after mixing. The mixture was tested at three different weight ratios as LP:H₂O₂:NH₄Br=(1) 1:1:40, (2) 1:1:10, (3) 1:3:10. For each ratio, there were a high concentration mix and a low concentration mix (Table 2). The results of the antibacterial activity of the mixed solutions are presented in Table 2.

TABLE 2
Bactericidal activity of mixed solution of LP/H₂O₂/NH₄Br versus the time after
mixing (tested in pulp slurry against P. aeruginosa)

| | | Log reduction | | | | | |
|---|---|---|---|---|---|---|---|
| | Component concentrations in mixed | at different times after mixing | | | | | |
| Ratio | solutions (g/100 mL) | 0 hr | 1 hr | 2 hr | 4 hr | 6 hr | 8 hr |
| 1:1:40 | 0.5% LP/0.5% H₂O₂/20% NH₄Br (H)* | 0 | 0 | 0 | 0 | 0 | 0 |
| | 0.1% LP/0.1% H₂O₂/4% NH₄Br (L) | 0 | 0 | 0 | 0 | 0 | 0 |
| 1:1:10 | 0.5% LP/0.5% H₂O₂/5% NH₄Br (H) | 0 | 0 | 0 | 0 | 0 | 0 |
| | 0.05% LP/0.05% H₂O₂/0.5% NH₄Br (L) | 2.5 | 0 | 0 | 0 | 0 | 0 |
| 1:3:10 | 0.5% LP/1.5% H₂O₂/5% NH₄Br (H) | >5 | >5 | 3.46 | 3.46 | 3.37 | 3.18 |
| | 0.05% LP/0.15% H₂O₂/0.5% NH₄Br (L) | >5 | 3.40 | 3.82 | 2.90 | 2.85 | 2.63 |

# The final concentration of individual components in the pulp slurry are as follows:
(1) 1:1:40 ratio - LP = 10 ppm; H₂O₂ = 10 ppm; NH₄Br = 400 ppm.
(2) 1:1:10 ratio - LP = 10 ppm; H₂O₂ = 10 ppm; NH₄Br = 100 ppm.
(3) 1:3:10 ratio - LP = 5 ppm; H₂O₂ = 15 ppm; NH₄Br = 50 ppm.
*(H) - high concentration mix.
(L) - low concentration mix.

It was found that the ratio of the components is critical for maintaining a stable antibacterial activity in the mixed solution after mixing the three components together. The concentration of individual components in the mixture was found to be not important. Both high and low concentration mixtures at the ratio of 1:3:10 maintained a relatively strong antibacterial activity for at least 8 hours after mixing. Previous data in Example 4 indicated that 1:1:40 is the best ratio when individual components are added to the pulp slurry separately. However, it was found that the 1:1:40 ratio is not effective when the three components are pre-mixed together and then applied as a mixture to the test system. An increase of H₂O₂ to 1:3:10 ratio was preferred in a pre-mixed solution to maintain a preferred stable activity.

### Example 6

### Antimicrobial Activity of LP-NH₄Br-Glucose Oxidase (GO)/Glucose in Pulp Substrate by Separate Addition Against Pseudomonas aeruginosa

Additional efficacy of the LP—NH₄Br-glucose oxidase (GO)/Glucose system was determined by the following test procedure: 0.04 g of glucose was added to 10 ml of sterile pulp substrate in a ½ -oz glass bottle to provide a 0.4% (w/v) glucose in the test system. 100 ppm of NH₄Br and 5 ppm of LP were added to 10 ml pulp substrate. Lastly, GO was added to the pulp slurry at various concentrations from 2.5 units/L to 5, 10, 20, 40, 50, 100, and 200 units/L. The same procedure was carried out for testing the GO-glucose system, except that NH₄Br and LP were not added to the pulp slurry. After all additions, the contents were mixed thoroughly and bacterial inoculum of P. aeruginosa was introduced to the bottles to give a concentration of about 3×10⁷ cells/ml. At 24 hours after inoculation, 1.0 ml content was taken from each bottle and plated on nutrient agar to 10⁻², 10⁻³, and 10⁻⁴ dilutions using biocide deactivation solution as the dilution blanks. All plates were incubated at 37° C. for 2-3 days and then the colonies in the plates were counted. The percent kill and log reduction was calculated based on cfu/ml of control and the treated culture. The control culture contained only bacterial cells in 10 ml pulp slurry.

The LP—NH₄Br-GO/Glu system was tested in pulp slurry for 24 hours with a fixed concentration of LP, NH₄Br, and glucose and GO concentrations ranging from 2.5 to 200 ppm, with the results shown in Table 3.

TABLE 3
Efficacy vs. P. aeruginosa of LP-NH₄Br-GO/Glu system
in pulp slurry at various GO concentrations (24 hr treatment)

| | | | | |
|---|---|---|---|---|
| LP (ppm) | NH₄Br (ppm) | Glucose % | GO (U/L) | Log Reduction |

| | | | | |
|---|---|---|---|---|
| 5 | 100 | 0.4 | 2.5 | 0.07 |
| 5 | 100 | 0.4 | 5 | 2.67 |
| 5 | 100 | 0.4 | 10 | 3.64 |
| 5 | 100 | 0.4 | 20 | >5.6 |
| 5 | 100 | 0.4 | 40 | >5.6 |
| 5 | 100 | 0.4 | 50 | >5.6 |
| 5 | 100 | 0.4 | 100 | >5.6 |
| 5 | 100 | 0.4 | 200 | >5.6 |

As GO concentration increased to 5 and 10 U/L, the system generated antibacterial activity (2.6 to 3.6 logs reduction). As GO concentration further increased to 20 U/L or above, the system yielded a strong antibacterial activity, producing >5.6 logs reduction (Table 3). Accordingly, to achieve >5 logs reduction, the preferred GO concentration is about 20 U/L (equivalent to 0.5 ppm) or higher.

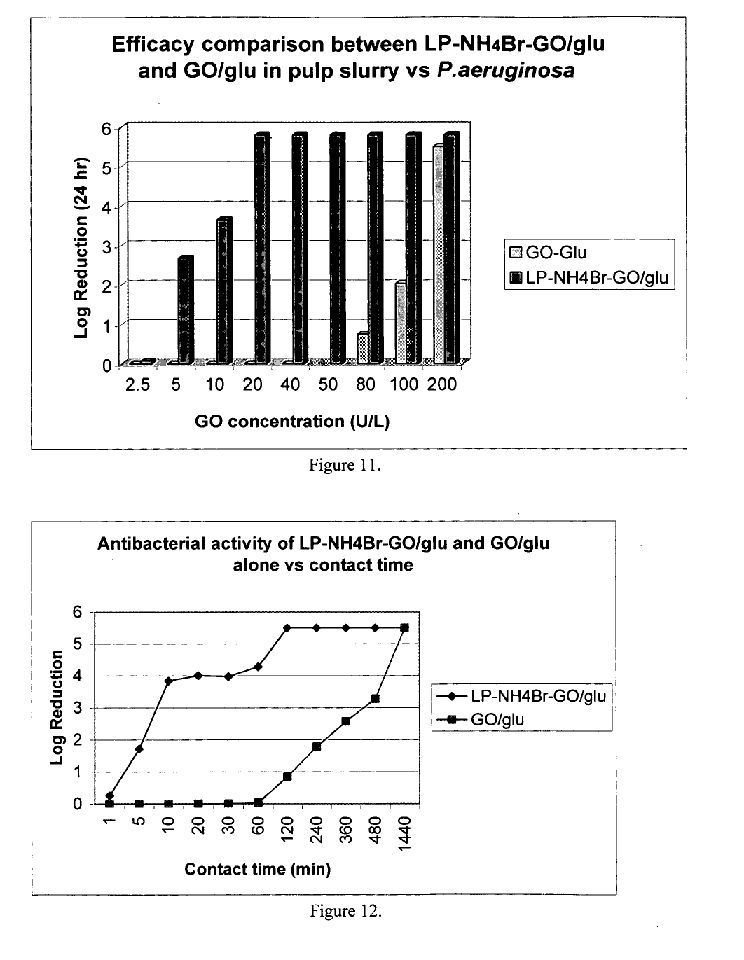

A comparison of the antibacterial efficacy of the LP—NH₄Br-GO/Glu system versus GO/Glu alone is illustrated in FIG. 11. The two systems were compared in the same GO concentration range. It was found that the LP—NH₄Br-GO/Glu system generates efficacy at 5 U/L of GO, while GO/Glu alone requires a much higher GO concentration (80 U/L) to start generating efficacy. Only 20 U/L of GO for the LP—NH₄Br-GO/Glu system achieves >5 logs reduction, whereas 200 U/L of GO generates >5 logs reduction if GO/glu is used alone (FIG. 11). The LP—NH₄Br-GO/Glu system demonstrated much stronger antibacterial activity than GO/glu acting alone. Since the GO/Glu system produces only H₂O₂ as an antimicrobial agent, these result suggest that the LP—NH₄Br-GO/Glu system generates bromine-related antimicrobial compounds that are stronger than H₂O₂.

A Time-Kill study for the LP—NH₄Br-GO/Glucose and GO-Glucose systems was carried out by the following procedure: 0.04 g of glucose, 50 ppm of NH₄Br and 2 ppm of LP were added to 10 ml of sterile pulp substrate in a ½ -oz glass bottle. Lastly, 20 units/L of GO the pulp slurry. For the GO/glu only system, only 0.04 g glucose and 200 units/L of GO were added to 10 ml pulp slurry. After all additions, the contents were mixed thoroughly and the bottle was inoculated by introducing about 3×10⁷ cells/ml of P. aeruginosa. At certain contact times after inoculation (from 1 min to 5, 10, 20, 30 min, and 1 hr, 2, 4, 6, 8, and 24 hr), 1.0 ml content was taken from the treated culture and plated on nutrient agar to 10⁻², 10⁻³, and 10⁻⁴ dilutions using biocide deactivation solution as the dilution blanks. The plates were incubated at 37° C. for 2-3 days. The colonies in the plate were counted and the percent kill and log reduction were calculated based on cfu/ml of control and the treated culture.

The LP—NH₄Br-GO/Glu system was tested at the optimal GO concentration (20 U/L) in pulp substrate versus contact time (or treatment time) for determining its killing rate. The values of Log reduction were measured at different contact times after inoculation. The GO/glu system at GO=200 U/L was included for comparison. The test results are shown in FIG. 12. As shown in the figure, the LP—NH₄Br-GO/Glu system demonstrated a quick killing action, reaching 4 logs reduction in 10 minutes contact time. The system produced a >5.5 logs reduction after a 2 hour treatment. The GO/Glu system, which generates H₂O₂ as the antimicrobial agent, showed a much slower killing rate. The GO/Glu system at a 10 times greater concentration of GO (200 vs 20 U/L) only yielded 1.0 log reduction after a 2 hour contact. It reached the level of >5.5 logs reduction after a 24-hour treatment, which is 22 hours slower than the LP—NH₄Br-GO/Glu system. The results suggest that bromine compounds, such as bromamine and HOBr, generated from the LP—NH₄Br-GO/Glu system provide a much faster killing rate than hydrogen peroxide generated from the GO/Glu system. The LP—NH₄Br-GO/Glu system has a potential application as a sanitizer/disinfectant because of its fast killing behavior.

### Example 7

### pH Effect on the Antimicrobial Activity of LP—NH₄Br—H₂O₂ System

The effect of pH on the antimicrobial activity of the LP—NH₄Br—H₂O₂ was determined as follows: LP was pre-mixed with NH₄Br in tap water to form a solution. The solution was then adjusted to different pH values with NaOH or HCl. This pH-adjusted LP/NH₄Br solution was then mixed with a diluted H₂O₂ solution to form a final mixed solution that contained all three components and possessed antimicrobial activity. The final mixed solution was added to pulp slurry to give desired concentrations of the components for evaluating the antimicrobial activity of the LP system.

A typical preparation of pre-mixed solution of LP—NH₄Br—H₂O₂ with pH adjustment may be described by the following. 0.5 grams of NH₄Br and 0.05 grams of LP were added to 50 mL of tap water in a 4-oz glass bottle, and mixed well to produce a solution having a pH of 6.95. HCl (1N) was used to adjust the LP—NH₄Br solution to pH 2.92. In a separate 4-oz bottle, 0.5 grams of H₂O₂ (30%) was added to 50 mL of tap water to form a diluted H₂O₂ solution (pH ˜6.5). The diluted H₂O₂ solution was slowly poured into the LP—NH₄Br solution and mixed gently to generate a mixed solution containing all three components. The final mixed solution had a pH of 3.4 and contained 0.05% LP, 0.15% H₂O₂, and 0.5% NH₄Br. Immediately after mixing all three components into the solution, 0.2 mL of the mixed solution of LP—NH₄Br—H₂O₂ was added to 10 mL pulp slurry to give 10 ppm of LP, 30 ppm of H₂O₂, and 100 ppm of NH₄Br in pulp substrate. Antibacterial test were conducted following the procedure described in Example 1 and the results are shown in Table 4.

TABLE 4
pH effect on the antimicrobial efficacy of LP-NH₄Br—H₂O₂ versus
P. aeruginosa in pulp slurry with 18 hour treatment time

| | | | | | | |
|---|---|---|---|---|---|---|
| pH of the mixed | 3.4 | 4.7 | 6.1 | 6.9* | 8.2 | 8.9 |
| solution | | | | | | |
| Log Reduction | 3.19 | 2.97 | 3.17 | >5.7 | >5.7 | 2.23 |
| (18 hr treatment) | | | | | | |

*The mixed solution of LP-NH₄Br—H₂O₂ having a pH of 6.9 was prepared by mixing the three components without pH adjustment.

As shown above, the pH of the pre-mixed solution of LP—NH₄Br—H₂O₂ can have an effect on the antimicrobial efficacy of the system. The best condition is mixing three components in water without pH adjustment or adjusting the pH to a slightly alkaline condition. The pH of the pre-mixed solution without pH adjustment is around neutral.

### Example 8

### Comparison of the Antimicrobial Efficacy of NaBr/(NH₄)₂SO₄ Versus NH₄Br as Halide and Ammonium Source for LP-Systems

The antibacterial activities of LP-systems containing NaBr/(NH₄)₂SO₄ as a halide source and an ammonium source were evaluated in pulp slurry and compared with LP-systems containing NH₄Br. Individual components of the LP-systems were added separately to pulp slurry to form various LP-antimicrobial systems. A test procedure similar to that described in Example 2 was used for the present evaluation. A comparison of the antibacterial activities of the LP—H₂O₂—NaBr/(NH₄)₂SO₄ system versus the LP—H₂O₂—NH₄Br system against Ps. aeruginosa in pulp slurry is shown in Table 5. It was found that the LP—H₂O₂—NaBr/(NH4)₂SO₄ system produced a level of activity that was the same as or slightly better than that of LP—H₂O₂—NH₄Br

TABLE 5
Comparison of bactericidal efficacy of LP-H₂O₂—NaBr/
(NH₄)₂SO₄ versus LP-H₂O₂—NH₄Br
in pulp slurry against Ps. aeruginosa (24-hr treatment by
separate additions).

| LP | H₂O₂ | NaBr | | NH₄Br | |
|---|---|---|---|---|---|
| (ppm) | (ppm) | (ppm) | (NH₄)₂SO₄ (ppm) | (ppm) | Log Reduction |
| 1 | 1 | 40 | 40 | 0 | 2.54 |
| 1 | 1 | 50 | 50 | 0 | >5.6 |
| 1 | 1 | 80 | 80 | 0 | >5.6 |
| 1 | 1 | 0 | 0 | 40 | 2.2 |
| 1 | 1 | 0 | 0 | 50 | 4.0 |
| 1 | 1 | 0 | 0 | 80 | >5.6 |

Similarly, NaBr/(NH₄)₂SO₄ was compared with NH₄Br in the LP-GO/glucose systems. Table 6 shows the antibacterial activities of the LP-GO/glu-NaBr/(NH4)₂SO₄ system verus the LP-GO/glu-NH₄Br system against Ps. aeruginosa in pulp slurry by separate additions. The LP-GO/glu-NaBr/(NH₄)₂SO₄ system generated a level of activity that was the same as or slightly better than that of the LP-GO/glu-NH₄Br system (Table 6).

It is concluded that the combination of two water-soluble salts, namely, NaBr and (NH₄)₂SO₄ has the same effectiveness as or a slightly better effectiveness than NH₄Br as a halide source and an ammonium source for producing antimicrobial agents in the LP-systems.

TABLE 6
Comparison of bactericidal efficacy of LP-GO/glu-NaBr/
(NH4)2SO4 versus LP-
GO/glu-NH4Br in pulp slurry against Ps. aeruginosa (24-hr
treatment by separate additions).

| LP | GO | Glucose | NaBr | (NH₄)₂SO₄ | NH₄Br | Log |
|---|---|---|---|---|---|---|
| (ppm) | (ppm) | (ppm) | (ppm) | (ppm) | (ppm) | Reduction |
| 2 | 1 | 1000 | 40 | 40 | 0 | >5.6 |
| 2 | 1 | 1000 | 50 | 50 | 0 | >5.6 |
| 2 | 1 | 1000 | 60 | 60 | 0 | >5.6 |
| 2 | 1 | 1000 | 0 | 0 | 40 | 5.26 |
| 2 | 1 | 1000 | 0 | 0 | 50 | >5.6 |
| 2 | 1 | 1000 | 0 | 0 | 60 | >5.6 |

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method of controlling the growth of at least one microorganism in an aqueous system or on a substrate capable of supporting a growth of said microorganism, the method comprising:
providing a) a lactoperoxidase, b) a peroxide source, c) a halide or a thiocyanate, wherein the halide is not a chlorine, and optionally, d) an ammonium source under conditions wherein the lactoperoxidase, peroxide from peroxide source, halide or thiocyanate and, optionally, ammonium from the ammonium source, interact to provide an antimicrobial agent to said aqueous system or said substrate and wherein said antimicrobial agent controls the growth of at least one microorganism in the aqueous system or on the substrate.

2. The method of claim 1, wherein the lactoperoxidase is obtained from mammalian milk.

3. The method of claim 1, wherein the lactoperoxidase is obtained from bovine milk.

4. The method of claim 1, wherein the peroxide source is hydrogen peroxide.

5. The method of claim 1, wherein the peroxide source is carbamide peroxide, percarbonate, perborate or persulfate, or combinations thereof.

6. The method of claim 1, wherein the peroxide source is an enzymatic hydrogen peroxide generating system that comprises a hydrogen peroxide generating enzyme and an enzyme substrate that is acted upon by the enzyme to produce hydrogen peroxide.

7. The method of claim 1, wherein the hydrogen peroxide generating enzyme is glucose oxidase and the enzyme substrate is glucose.

8. The method of claim 1, wherein the halide is in the form of a halide salt of an alkaline metal or alkaline earth metal.

9. The method of claim 1, wherein the halide is ammonium bromide, sodium bromide, potassium bromide, calcium bromide, magnesium bromide, sodium iodide, potassium iodide, ammonium iodide, calcium iodide, or magnesium iodide, or combinations thereof.

10. The method of claim 1, wherein the halide is potassium iodide.

11. The method of claim 1, wherein the thiocyanate is sodium thiocyanate, ammonium thiocyanate, or potassium thiocyanate, or combinations thereof.

12. The method of claim 1, wherein the ammonium source is an ammonium salt.

13. The method of claim 1, wherein the halide and the ammonium source are both provided by an ammonium halide.

14. The method of claim 1, wherein the halide and the ammonium source are both provided by ammonium bromide.

15. The method of claim 1, wherein the halide is sodium bromide and the ammonium source is ammonium sulfate.

16-23. (canceled)

24. The method of claim 1, wherein the antimicrobial agent is provided to the aqueous system or substrate by combining the lactoperoxidase, peroxide source, halide or thiocyanate, and, optionally, an ammonium source with water to form a concentrated solution in which the lactoperoxidase, peroxide from the peroxide source, the halide and, optionally, ammonium from the ammonium source interact to provide an antimicrobial agent in the concentrated solution and then applying the concentrated solution to the aqueous system or the substrate.

25-36. (canceled)

37. The method of claim 1, wherein the antimicrobial agent is provided to the aqueous system or substrate by adding the lactoperoxidase, peroxide source, halide or thiocyanate, and, optionally, the ammonium source, separately to the aqueous system or the substrate under conditions wherein the antimicrobial agent is formed in situ in the aqueous system or on the substrate.

38. (canceled)

39. The method of claim 1, wherein the controlling growth of microorganisms in an aqueous system is carried out by providing the antimicrobial agent to intake water of a metal working system, a cooling water system, a waste water system, a food processing system, a drinking water system, a leather-processing water system, a white water system for paper-making process, a paper-making system or a paper-processing system.

40. A method of killing or inhibiting the growth of microorganisms in an aqueous system or on a substrate capable of supporting a growth of microorganisms, the method comprising:
providing a first water soluble container containing, in solid form, a lactoperoxidase, a halide or a thiocyanate, wherein the halide is not a chloride, optionally an ammonium source, and an enzyme substrate of an enzyme that has the property of acting upon the enzyme substrate to produce hydrogen peroxide,
providing a second water soluble container containing, in solid form, an enzyme that has the property of acting upon the enzyme substrate to produce hydrogen peroxide,
adding the first water soluble container and the second water soluble container to water under conditions wherein the enzyme that has the property of acting upon the enzyme substrate to produce hydrogen peroxide acts upon the enzyme substrate to produce hydrogen peroxide and wherein the lactoperoxidase, hydrogen peroxide, halide and, optionally, ammonium from the ammonium source, interact to form an antimicrobial agent, and
providing the antimicrobial agent to an aqueous system or a substrate and wherein the antimicrobial agent inhibits the growth of microorganisms in the aqueous system or on the substrate.

41. The method of claim 40, wherein the step of adding the first water soluble container and the second water soluble container to water under conditions wherein the enzyme that has the property of acting upon the enzyme substrate to produce hydrogen peroxide acts upon the enzyme substrate to produce hydrogen peroxide and wherein the lactoperoxidase, hydrogen peroxide, halide and, optionally, ammonium from the ammonium source, interact to form an antimicrobial agent, is carried out by the steps of
dissolving the first water soluble container in water to form a first concentrated solution containing a lactoperoxidase, a halide or a thiocyanate, optionally an ammonium source, and an enzyme substrate of an enzymatic hydrogen peroxide generating system,
dissolving the second water soluble container in water to form a second concentrated solution containing an enzyme that has the property of acting upon the enzyme substrate to produce hydrogen peroxide, wherein the second concentrated solution is not in contact with the first concentrated solution, and then,
adding the first concentrated solution and the second concentrated solution separately to an aqueous system or a substrate to be treated under conditions wherein the antimicrobial agent is formed in situ in the aqueous system or on the substrate.

42. The method of claim 40, wherein the enzyme that has the property of acting upon an enzyme substrate to produce hydrogen peroxide is glucose oxidase and the enzyme substrate is glucose.

43. A composition comprising lactoperoxidase, a peroxide source, a halide or a thiocyanate, wherein the halide is not a chloride, and, optionally, an ammonium source.

44. The composition of claim 43 wherein the peroxide source is hydrogen peroxide.

45. The composition of claim 43 wherein the peroxide source is carbamide peroxide, percarbonate, perborate or persulfate, or combinations thereof.

46. The composition of claim 43, wherein the peroxide source is an enzymatic hydrogen peroxide generating system that comprises a hydrogen peroxide generating enzyme and an enzyme substrate that is acted upon by the enzyme to produce hydrogen peroxide.

47. The composition of claim 43, wherein the hydrogen peroxide generating enzyme is glucose oxidase and the enzyme substrate is glucose.

48. The composition of claim 43, wherein the halide is in the form of a halide salt of an alkaline metal or alkaline earth metal.

49. The composition of claim 43, wherein the halide is ammonium bromide, sodium bromide, potassium bromide, calcium bromide, magnesium bromide, sodium iodide, potassium iodide, ammonium iodide, calcium iodide, or magnesium iodide, or combinations thereof.

50. The composition of claim 43, wherein the halide is potassium iodide.

51. The composition of claim 43, wherein the thiocyanate is sodium thiocyanate, ammonium thiocyanate, or potassium thiocyanate, or combinations thereof.

52. The composition of claim 43, wherein the ammonium source is an ammonium salt.

53. The composition of claim 43, wherein the halide and the ammonium source are both provided by an ammonium halide.

54. The composition of claim 43, wherein the halide and the ammonium source are both provided by ammonium bromide.

55. The composition of claim 43, wherein the halide is sodium bromide and the ammonium source is ammonium sulfate.

56. (canceled)

57. A composition comprising lactoperoxidase and ammonium bromide.

58. A composition comprising lactoperoxidase, sodium bromide, and ammonium sulfate.

59-73. (canceled)

74. The composition of claim 47, wherein the composition is maintained in a substantially non-reacting form for a period of time by keeping the glucose oxidase physically separated from the lactoperoxidase, glucose, halide or thiocyanate, and optional ammonium source.

75. The composition of claim 74, wherein the glucose oxidase is kept under anaerobic conditions.

76. The composition of claim 74, wherein the lactoperoxidase, glucose, halide or thiocyanate, and optional ammonium source are kept in a first water-soluble container and glucose oxidase is kept in a second water-soluble container or wherein the lactoperoxidase, glucose, glucose oxidase, halide or thiocyanate, and optional ammonium source are contained in a container that has at least one separate compartment so that the glucose oxidase is physically separated from the lactoperoxidase, glucose, halide or thiocyanate, and optional ammonium source.

77-79. (canceled)

80. A method of controlling the growth of at least one microorganism in or on a product, material, or medium susceptible to attack by a microorganism, the method comprising adding to the product, material, or medium the composition of claim 43.

81. The method of claim 80, wherein the material or medium is in the form of a solid, a dispersion, an emulsion, or a solution.
